(19) United States
(12) Patent Application Publication
(10) Pub. No.: US 2017/0137179 A1
(43) Pub. Date: May 18, 2017

(54) METHOD OF MAKING BAGS WITH VALVE FROM A WEB OF POLYMERIC WOVEN FABRIC AND BAG THEREOF

(71) Applicant: Ashok CHATURVEDI, New Delhi (IN)

(72) Inventor: Ashok CHATURVEDI, New Delhi (IN)

(21) Appl. No.: 15/314,577

(22) PCT Filed: May 29, 2015
(86) PCT No.: PCT/IN2015/000224

§ 371 Date: Nov. 29, 2016

(30) Foreign Application Priority Data
May 29, 2014 (IN) 1417/DEL/2014

(51) Int. Cl. B65D 30/18; B65B 51/26; B65B 51/02; B05D 1/26; B65B 51/22; B65D 33/01; B05D 3/06; B65B 9/22; B65B 61/06

(52) U.S. Cl. CPC B65D 31/08; B65B 9/22; B65B 51/26; B65B 51/02; B65B 61/06; B65B 51/225; B65D 33/01; B05D 3/06; B05D 1/265

(57) ABSTRACT

A method (100) for making a flat bottom bag (800) with a valve (28) is provided. The method (100) includes overlapping and sealing the two longitudinal edges (11a and 11b) of a web (10) to form a continuous tube (12). The method includes cutting-off the continuous tube into tube pieces (14) in accordance with desired bag length such that each tube piece (14) has at least a first open end (18) and a second open end (22). The method (100) includes forming a first pair of flaps (F1, F2) and a second pair of flaps (F3, F4) on the first open end (18) and the second open end (22) respectively. The method (100) includes providing a valve (28) on the second pair of flaps (F3, F4) on the second open end (22). The method (100) includes folding and flattening both the pairs of flaps (F1, F2 and F3, F4) so that the edges of the flaps meet at the centre. The method (100) includes sealing a pre-cut cover patch (30) onto the folded and flattened pairs of flaps (F1, F2 and F3, F4) to close the open ends (18, 22).

### FIELD OF THE INVENTION

The invention generally relates to flexible packaging and more particularly relates to bags made of polymeric woven fabric such as Woven Polypropylene (WPP), or Woven Poly Ethylene (WPE).

### BACKGROUND OF THE INVENTION

In the field of flexible packaging, especially packages made from Woven Polypropylene (WPP) or High Density Woven Polyethylene (WPE), the tube is flattened and extrusion coating is done on both sides of the flattened tube. Subsequently, the tube is pressed & cooled. As a process limitation the extrusion coating width is kept more than the width of the woven fabric tube which is then trimmed at the edges leaving some width of extrusion coating layers fused together. These protruded extrusion coating edges on the side edges of the tube spoils the aesthetic value of the package and only surface printing is possible on both the sides of the tube separately only restricting the possibility of having registered and continuous printed matter of pictures etc.

Therefore, there exists a need to develop packages having allover coating for continuous and registered printing all around, having gloss, rub resistance, improved barrier properties with possibility of having extrusion coated inside surface of the packages. The process should be cost effective and the package must not look shabby.

### SUMMARY OF THE INVENTION

In view of the foregoing limitations inherent in the prior-art, an object of the invention is to provide flat bottom bag having allover coating for continuous printing having gloss, rub resistance with possibility of having extrusion coated inside surface of the bag. The process is cost effective and the bag must not look shabby and some added advantages.

Accordingly, in one aspect, the invention provides a method for making a flat bottom bag with a valve. The method includes the steps of overlapping and sealing the two longitudinal edges of a web to form a continuous tube. The method further includes cutting-off the continuous tube into tube pieces in accordance with desired bag length such that each tube piece has at least a first open end and a second open end. Further, the method includes forming a first pair of flaps and a second pair of flaps on the first open end and the second open end respectively. The method includes providing a valve on the second pair of flaps on the second open end. Moreover, the method includes the step of folding and flattening both the pairs of flaps at both the open ends of the tube piece so that the edges of the flaps meet at the centre. Furthermore, the method includes the step of sealing a pre-cut cover patch onto the folded and flattened pairs of flaps at both the ends of the tube piece to close the open-ends to form the bag.

These together with the other aspects of the invention, along with the various features of novelty that characterize the invention, are pointed out with particularity in the description, along with the abovementioned summary, annexed hereto and form a part of the invention. For a better understanding of the invention, its operating advantages and the specified object attained by its uses, reference should be made to the accompanying drawings and descriptive matter in which there are illustrated exemplary embodiments of the invention.

### BRIEF DESCRIPTION OF THE DRAWINGS

The advantages and features of the invention shall be better understood with reference to the following description taken in conjunction with the accompanying drawing, wherein like elements are identified with like symbols and in which:

FIG. 1 is a flowchart illustrating a process of making a flat bottom bag in accordance with an embodiment of the invention;

FIG. 2 is a diagrammatic depiction of the process of making the flat bottom bag in accordance with an embodiment of the present invention;

FIG. 3 is a diagrammatic depiction of a step of making continuous tube from the web in accordance with an embodiment of the present invention;

FIG. 4 is a diagrammatic depiction of cutting-off the continuous tube into tube pieces of bag length required in accordance with an embodiment of the present invention;

FIGS. 5A-E are diagrammatic depictions of steps of forming a pair of flaps of open-ends of the tube pieces, sealing a cut laminate piece and sealing a pre-cut cover patch in accordance with an embodiment of the present invention;

FIG. 6 and FIG. 6A are cross sectional views of the structure of webs in accordance with an embodiment of the present invention;

FIGS. 7- 7A is a flowchart illustrating a process of making a flat bottom bag in accordance with another embodiment of the present invention; and

FIG. 8 is an isometric view of the flat bottom bag with valve, in accordance with an embodiment of the present invention.

Like reference numerals refer to like parts throughout the description of several views of the drawings.

### DESCRIPTION OF THE INVENTION

For a thorough understanding of the invention, reference is to be made to the following description in connection with the above-mentioned drawings. Although the invention is described in connection with exemplary embodiments, the invention is not intended to be limited to the specific forms set forth herein. It is understood that various omissions and substitutions of equivalents are contemplated as circumstances may suggest or render expedient, but these are intended to cover the application or implementation without departing from the spirit or scope of the invention. Further, it will nevertheless be understood that no limitation in the scope of the invention is thereby intended, such alterations and further modifications in the figures and such further applications of the principles of the invention as illustrated therein being contemplated as would normally occur to one skilled in the art to which the invention relates. Also, it is to be understood that the phraseology and terminology used herein is for the purpose of description and should not be regarded as limiting. Further, reference herein to “one embodiment” or “an embodiment” means that a particular feature, characteristic, or function described in connection with the embodiment is included in at least one embodiment of the invention. Furthermore, the appearances of such phrase at various places herein are not necessarily all referring to the same embodiment. The terms “a” and “an” herein do not denote a limitation of quantity, but rather denote the presence of at least one of the referenced item.

Various embodiments of the invention provide a flat bottom bag with valve and a process for making a flat bottom bag with valve comprising the steps of overlapping and sealing the two longitudinal edges of a web to form a continuous tube; cutting-off the continuous tube into tubes of pre-set length having two open-ends—a first open-end and a second open-end; forming a pair of flaps of each of the open-ends—a first pair of flaps of the first open-end and a second pair of flaps of the second open-end of the tube; sealing a cut laminate piece to the first pair of flaps of the first open-end; folding and flattening both the pairs of flaps so that the edges of the flaps meet at the centre and whereby the cut laminate piece sealed to the first pair of flaps is folded to form a valve; and sealing a pre-cut cover patch onto the folded and flattened pairs of flaps to close the open-ends to form the bag.

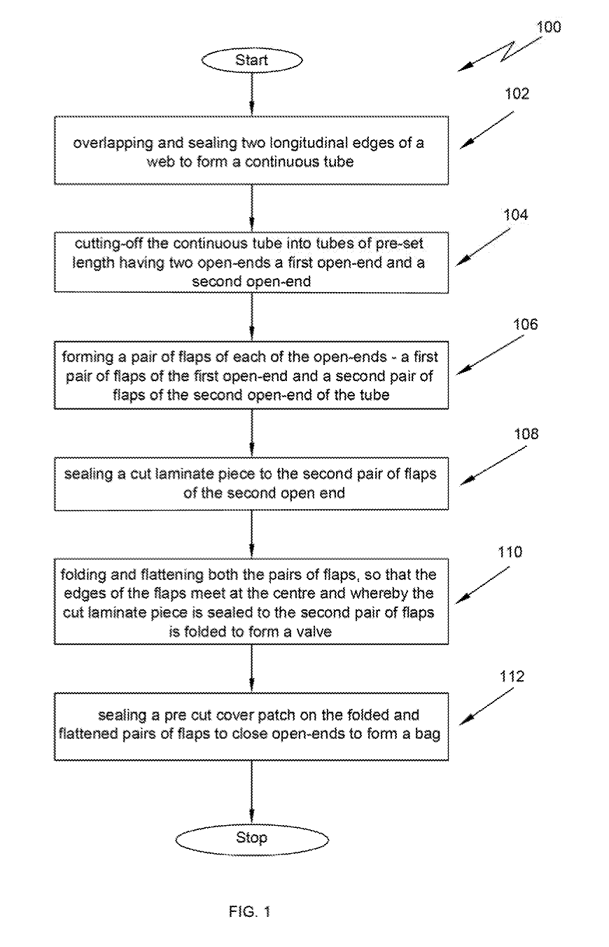

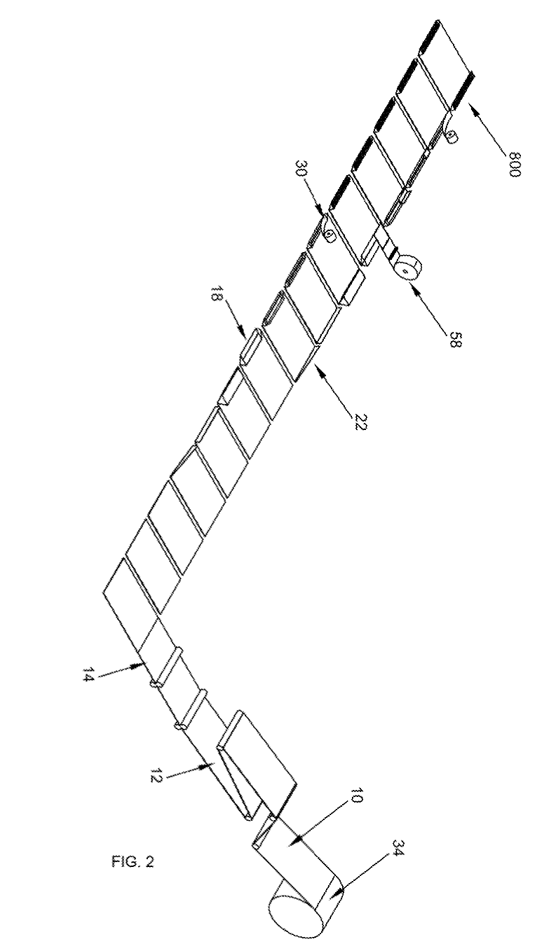

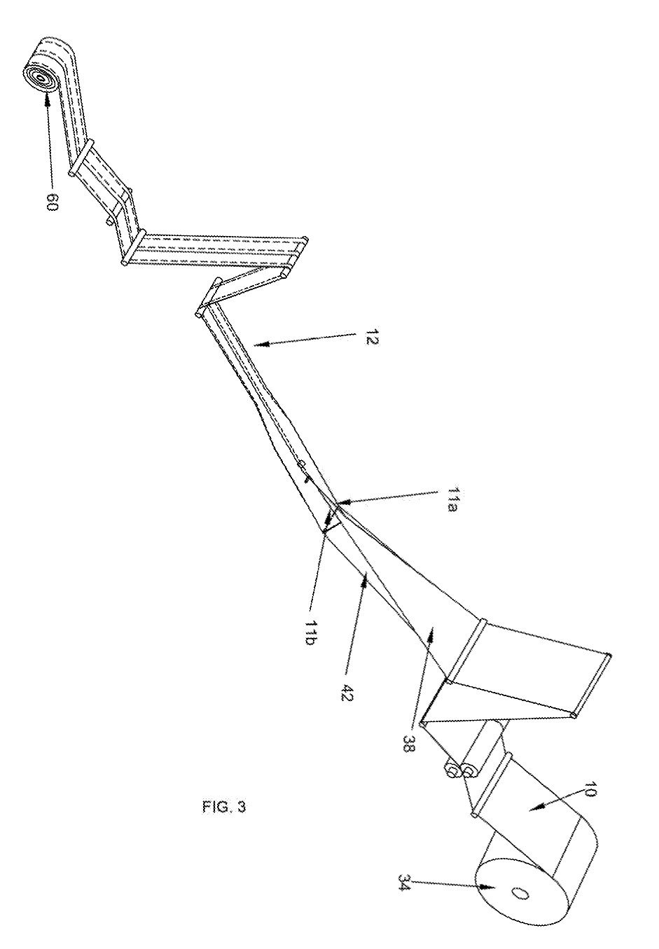

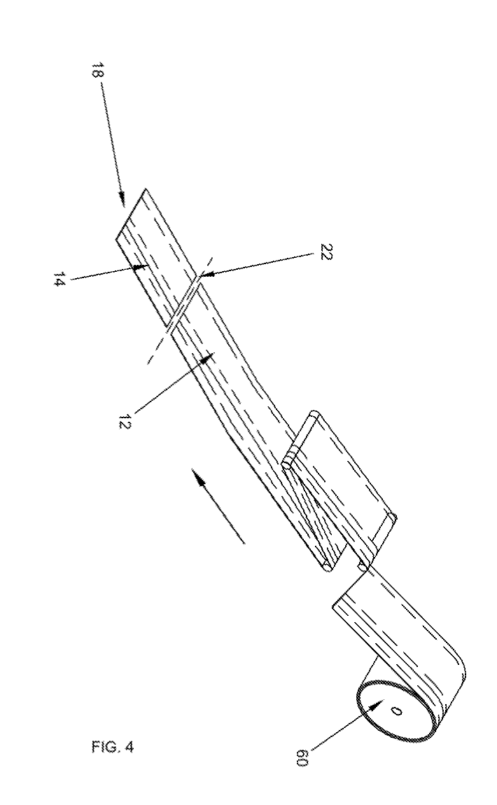

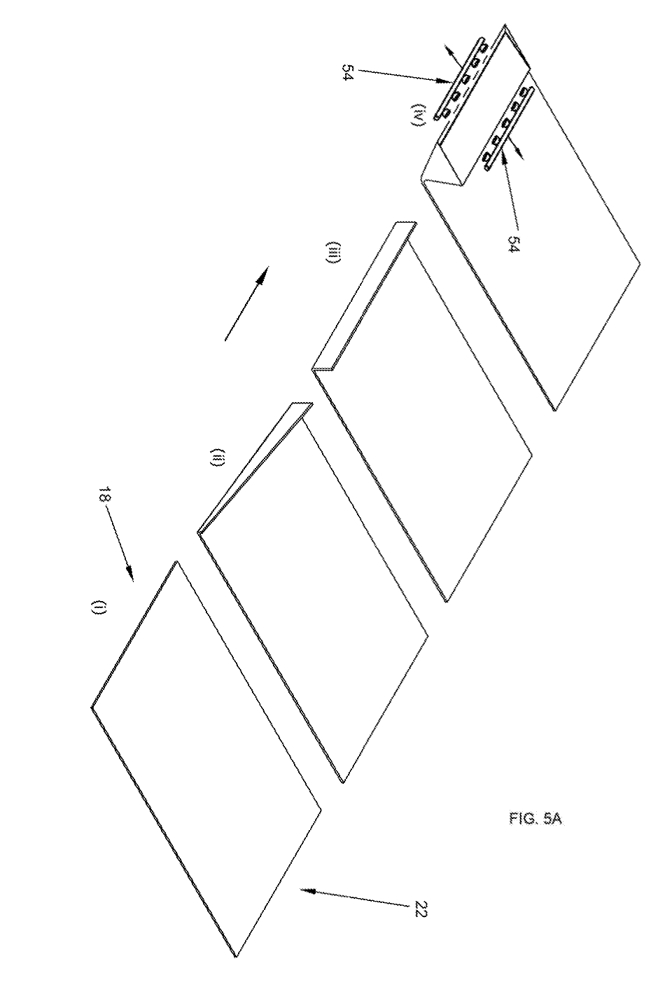

FIG. 1 is a flowchart and FIG. 2 is a diagrammatic representation of a method (100) of making a flat bottom bag with valve (hereinafter bag) in accordance with an embodiment of the invention. At step (102), overlapping and sealing of the two longitudinal edges (11a and 11b) of web (10) to form a continuous tube (12) is performed as shown in FIG. 3.

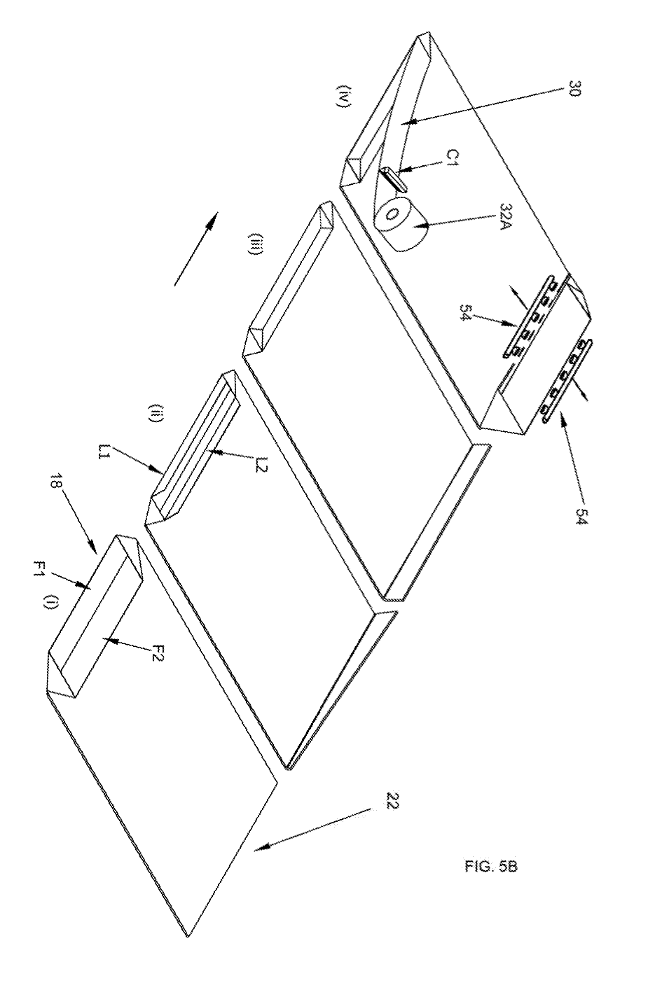

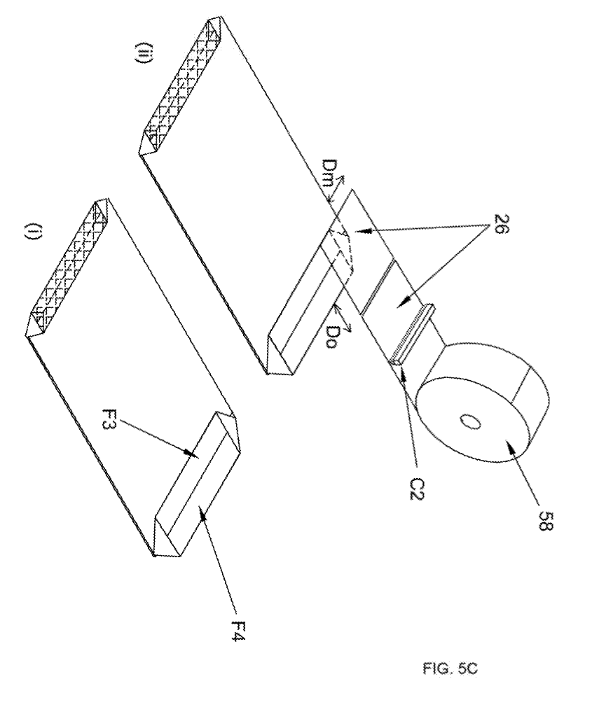

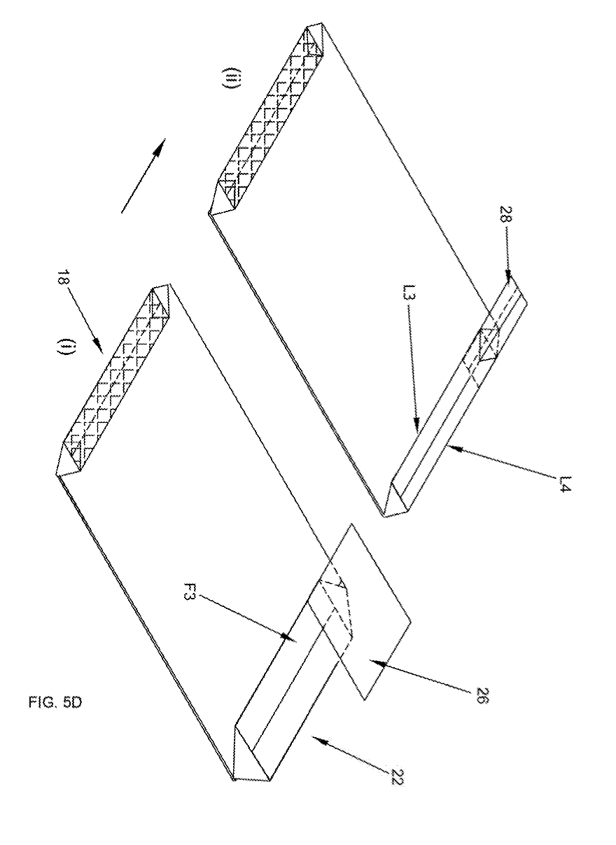

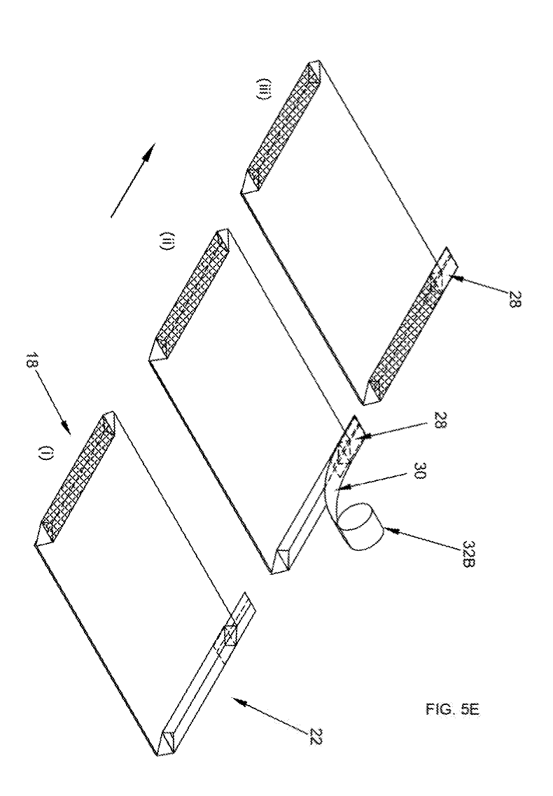

At step (104), the continuous tube (12) is cut-off into tube pieces (hereinafter referred to as the tube (14)) in accordance with the desired bag length of preset length. Tubes (14) so formed have two open-ends—a first open-end (18) and a second open-end (22) (as shown in FIGS. 4 and 5A (i)).

At step (106), pairs of flaps—a first pair of flaps (F1, F2) and a second pair of flaps (F3, F4) are formed at each of the first open-end (18) and second open-end (22) respectively (as shown in FIGS. 5A and 5B).

Further, at step (108), a cut laminate piece (26) is sealed to the second pair of flaps (F3, F4) on the second open-end (22) as shown in FIG. 5C(ii). At step (110), flattening of both the pairs of flaps (F1, F2 and F3, F4) is done, whereby the cut laminate piece (26) already sealed to the second pair of flaps (F3, F4) is folded to form a valve (28) shown in FIG. 5D(ii). At step (112), sealing of a pre cut-cover patch (30) onto each of the flattened pairs of flaps (F1, F2 and F3, F4) is done to close the open-ends of the tube (14) to form the bag as shown in FIG. 5B(iv) and FIG. 5E(ii). Here, the sealing of a pre cut-cover patch (30) completely closes and seals the first open-end (18) and the bag is filled with the content through the valve (28) formed at the second end (22).

In an embodiment, the method (100) includes step of pulling the web (10) from an unwinder (34) where web (10) is in the form of a roll on the unwinder (34) (as shown in FIG. 3).

In accordance with an embodiment of the invention, at step 102, the outer surface (42) and inner surface (38) of the web (10) overlap longitudinally near two edges of the web (11a & 11b) after folding of the web (10). The overlapped band is subsequently sealed thereat to form the continuous tube (12).

The sealed band along the continuous tube (12) may be further pressed and cooled. The continuous tube (12) so formed is either cut into pieces of tube (14) or wound in roll form over a rewinder (60) which is later unwound to release the continuous tube (12) for further processing. In various embodiments, the pre-set length of the tube (14) at step (104) depends upon the size of the bag to be formed.

In accordance with an embodiment of the invention, step (106) of process (100) includes steps of folding of the open-ends (18, 22) of the tube (14), spreading of the mouth of the folded open-ends (18, 22) of the tube (14), and flattening of each spread mouth of the folded open-ends to form the pair of flaps (F1, F2 and F3, F4). In an embodiment, the two ends (18, 22) are folded as shown in FIGS. 5A(ii) and (iii) and 5B(ii) and (iii) respectively.

In an embodiment, open-ends (18, 22) are spread by means of suction cups (54). It should be noted that FIG. 5A(iv) and 5B (i) shows the spreading and flattening of the first open-end (18) of the tube (14). The same is done on the second open-end (22) as well (shown in FIG. 5B(iv) and 5C(i)).

In an embodiment, at step (108), a roll (58) provides the cut laminate piece (26) which is placed offset from the edges of the tube (14).

The cut laminate piece (26) is cut from the roll (58) by means of a cutter (C2). As shown in FIG. 5C(ii), cut laminate piece (26) is protruding out of the edges of the tube (14) by an offset distance “Do” and mouth distance “Dm” from the side of flap F4. As a result, the valve (28) formed subsequently has a mouth for filling from the side of the bag.

In some embodiments, the mouth distance Dm can be zero or null so that valve (28) does not protrude out of the side of the bag. In an embodiment of the present invention, an open end of the valve (28) can be closed/sealed at the side ends of the bag, so that the insects and unwanted elements can be restricted from entering the bag. This may be required especially in case of packaging of food articles. It may be contemplated that the open mouth of the valve (28) may be sealed directly through the inner surface material of the cut laminate piece (26) or may be folded and sealed using any sealing methods known in the art.

In accordance with an embodiment of the invention as the cut laminate piece (26) is sealed at the second end (22) to the second pair of flaps (F3, F4), flaps (F3, F4) are flattened along lines L3 and L4 respectively along with the cut laminate piece (26) as shown in FIG. 5D(ii). It should be noted that the flap to which the distance has been left or offset while sealing the cut laminate piece (26) should be flattened first and should be overlapped by the opposite flap. For example, flaps F3 and F4 are flattened in such a manner that enables forming the valve (28) from the cut laminate piece (26) as shown in FIG. 5D(ii). Similarly, the flaps (F1, F2) are also flattened along lines L1 and L2 as shown in FIG. 5B (ii).

It may be noted that in the preferred embodiment no cut laminate piece is provided at flaps F1, and F2 and therefore, no valve formation happens thereat. Since the valve in the bag is required at one end only, therefore placing cut laminate piece and forming the valve at the first end (18) is redundant and therefore not required. However, embodiments are possible where addition of a cut laminate piece and subsequent formation of valve at either or both the pair of flaps may be done.

In an alternate embodiment, a valve in the form of an offline pre-formed tube can also be placed and sealed between flaps F3 and F4 to obtain a similar effect.

In an embodiment of the invention, the tube (14) is advanced for sealing of the pre-cut cover patch (30) onto the flattened pairs of flaps (F1-F2 and F3-F4) at step (112) as shown in FIG. 5B(iv) and FIG. 5E(ii). The flaps are so flattened that the edges meet at the center. In some embodiments they can be overlapping each other also. The cover patch (30) is in the roll form on a cover patch roll (32A and 32B) and is cut by means of a cutter (C1) as shown in FIG. 5B(iv). The cover patch (30) can also be fed in precut form using suitable mechanism.

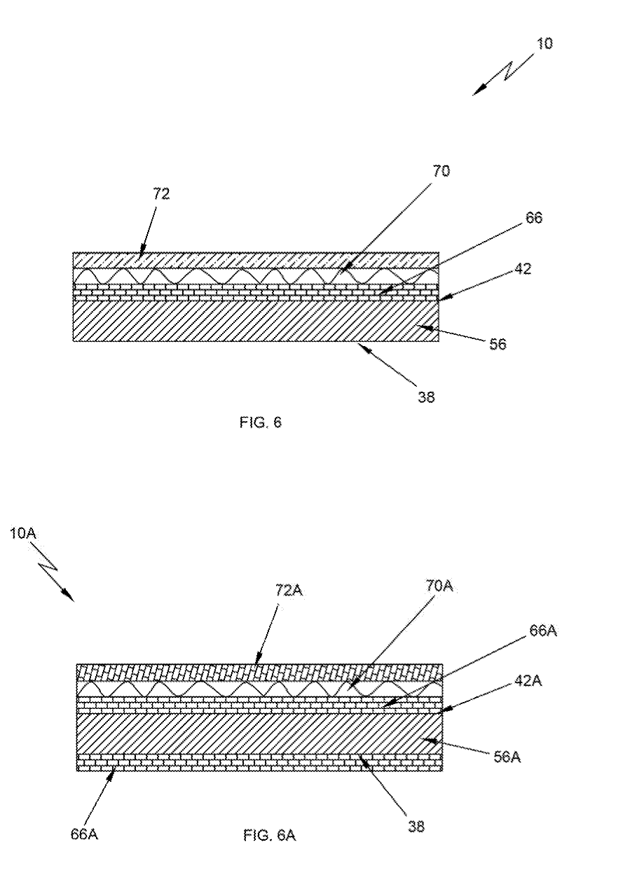

FIG. 6 is a cross sectional view of the web (10) depicting the structure thereof, in accordance with an embodiment of the invention. Web (10) is a printed or unprinted woven fabric made of a base layer (56) of a woven polymeric material such as Woven Polypropylene (WPP) or woven High Density Polyethylene (HDPE) having a first surface (outer surface 42) and a second surface (inner surface 38).

First surface (42) of the base layer (56) is provided with hot extrusion coating (66) to make the first surface (42) conducive to printing. The hot extrusion coating (66) may be of Polypropylene or Polyethylene or a combination of both.

Subsequently, web (10) may be printed on the first surface (42) over the hot extrusion coating shown as printed layer (70). Printed layer (70) may be further coated with E-beam curable layer or UV curable layer (72). It has been discussed later that curable layer may be applied on the whole surface of the web (10) excluding the portion of the surface along the edge (11b) of the web (10) which is overlapped by the other edge (11a) of the web (10) and sealed using hot air in particular over other methods of sealing. However same principle may be adopted if curable layer affects the sealing by any other method adversely.

As shown in FIG. 6A, in an embodiment, a film such as Biaxially Oriented Polypropylene (BOPP) or Polyethylene terephthalate (BOPET) (72A), may be surface printed or reverse-printed with text, graphics and/or product labeling etc., shown as (70A) and then adhered to the first surface (42A) of the base layer (56A) over the hot extrusion coating layer (66A) over the base layer (56) using adhesives, hot extrusion lamination or some other known means of attaching the two layers.

Inner surfaces (38 and 38A) may or may not be coated with hot extrusion layer (66A) of Polypropylene or Polyethylene or a combination of both and no printing or curing is performed on inner surface (38 and 38A) generally. The purpose of such coating is to provide smooth inside surface.

In various embodiments, the structure of the web of the pre-cut cover patch (30) is either similar to the web (10) or WPP/WPE fabric or WPP/WPE fabric with extrusion coating of Polypropylene or Polyethylene or a combination of both on one side or both the sides which may be unprinted or printed on outside and may or may not be subsequently coated with E-beam curable layer or UV curable layer (72), duly cured. However the cover patch (30) web may also be printed or unprinted, single layer or multilayer film or laminate having compatible surface material for sealing with flaps surface F1, F2, F3 & F4.

The substrate for cut laminate piece (26) for making valve (28) may be made up of either WPP/WPE fabric or WPP/WPE fabric with extrusion coating of Polypropylene or Polyethylene or a combination of both, on one side or both the sides. However the substrate for cut laminate piece (26) may also be single layer or multilayer film or laminate having compatible surface material for sealing with flaps surface F1, F2, F3, F4 and cover patch (30) at steps (108) and (112).

In various embodiments, sealing in processes (100) and (700) may be heat sealing, sealing with hot melt adhessive, hot air sealing, ultrasonic sealing, sealing using glue, sealing with hot extrusion layer or by Laser welding. The hot air sealing is done at temperature of about 700 deg. Celsius.

In an embodiment, where sealing at step (102) is performed by means of hot air, the surfaces of the web (10) in contact which need to be hot air sealed should not have E-beam curable layer or UV curable layer (72). Hence the band on the surface along the edge (11b) of the web (10) which is overlapped by the other edge (11a) of the web (10) is excluded from E-beam curable layer or UV curable layer (72). Similarly for hot air sealing at step (108) and (112) the surface of F1, F2, F3 and F4 coming in contact with the cover patch (30), should also be without E-beam curable layer or UV curable layer (72). To achieve this, uncoated bands are left after printing on the web (10) across it's width at predefined pitch depending upon the length of the cut tube required. The width of the uncoated bands is decided based upon the width of the sealing surfaces of the flaps F1, F2, F3 and F4.

However same principle may be adopted if E-beam curable layer or UV curable layer (72) adversely affects the sealing by any other method.

In an embodiment, process (100) and (700) includes a step of providing a seperator over the cut laminate piece to be folded to form Valve (28). The separator prevents inner surfaces of valve (28) from sealing with each other while sealing cover patch (30).

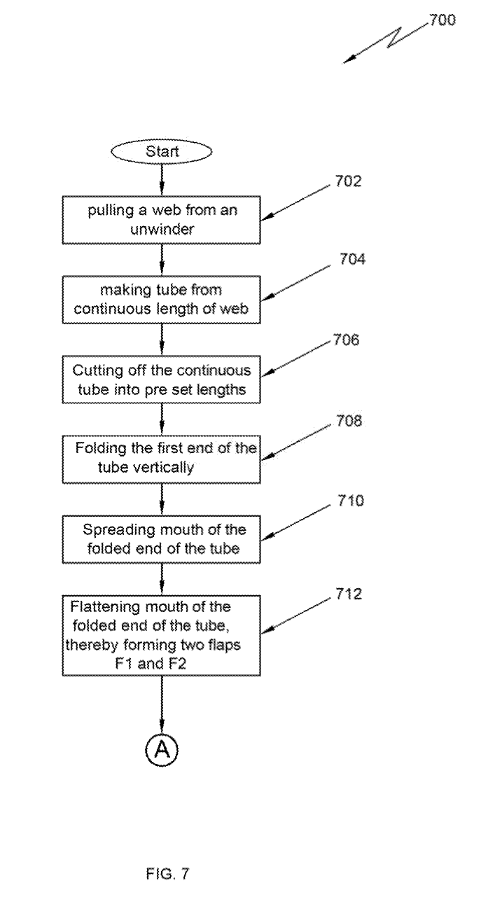

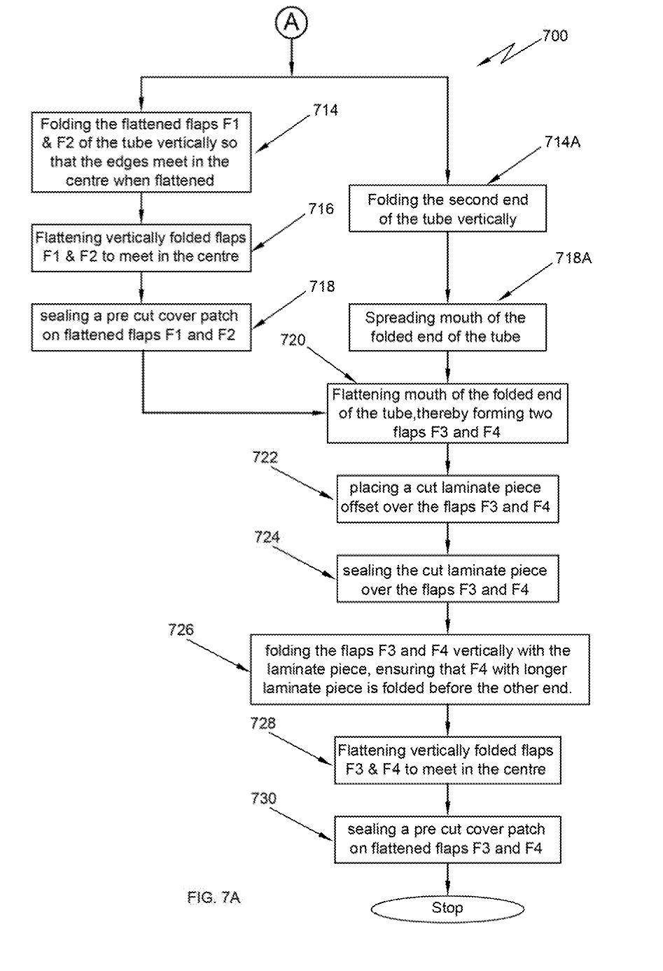

The sequence of the steps and each sub-step thereof of process (100) may be broken, altered and adjusted depending upon the requirement based upon constraints of space and machine design in-line with process and manufacturing optimization. In view of the same, one of the preferred embodiments of the process of the invention is discussed with reference to a flow chart in FIGS. 7 and 7A depicting a process 700 in accordance with an embodiment of the invention.

At step (702) in process (700), the web (10) is pulled from an unwinder (34). At step (704), continuous tube (12) is made from the continuous length web by passing through folders. At step (706), cutting-off of the continuous tube into pre-set length tubes (14) is performed. At step (708), first end (18) of the tube (14) is folded vertically. At step (710), mouth of the folded first end (18) of the tube (14) is spread. At step (712), flattening of the mouth of the folded first end of the tube to form flaps (F1, F2) is done.

Subsequently, steps (714) and (714A) are performed simultaneously, wherein at step (714), folding of the flattened flaps (F1, F2) of the tube vertically is done so that the edges of the flaps meet in the centre when flattened and simultaneously, at step (714A), the second end of the tube is folded vertically.

Thereafter, at step (716), flattening of vertically folded flaps (F1, F2) to meet at the centre is done.

Thereafter, steps (718) and (718A) are performed simultaneously, wherein at step (718), sealing of pre-cut cover patch over flattened flaps (F1, F2) of the first end of the tube and at step (718A), spreading of the mouth of the folded second end of the tube is performed.

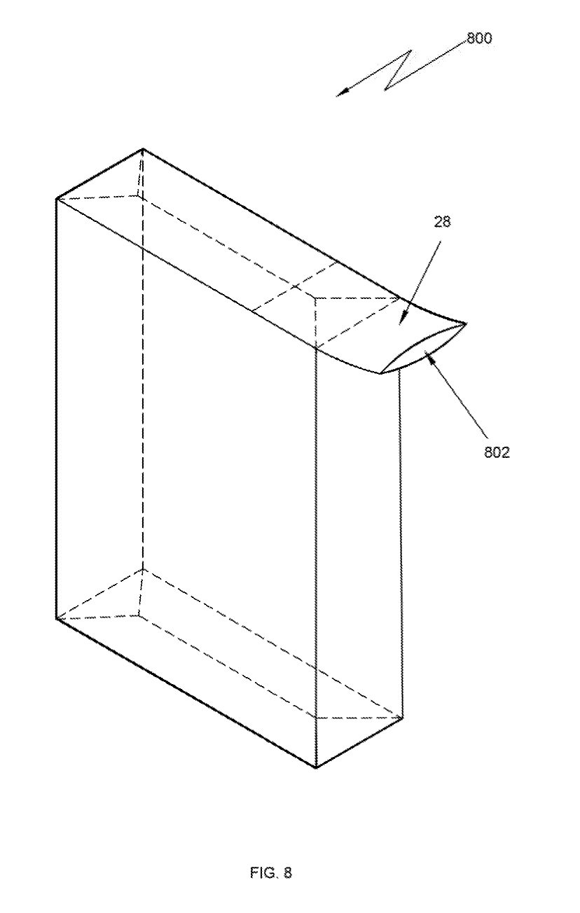

Thereafter, steps (720 to 730) are performed, which pertain to the second end of the tube. At step (720), flattening of the mouth of the folded second end of the tube is done to form two flaps (F3, F4). At step (722), a cut laminate piece is placed offset over the flaps (F3, F4). At step 724, sealing of the cut laminate piece over the flaps (F3, F4) is done. At step (726), flaps (F3, F4) are folded vertically along with the laminate piece, ensuring that F4 with the longer laminate piece is folded before the other end. At step (728), vertically folded flaps (F3, F4) are flattened to meet at the centre. At step (730), sealing of a pre-cut cover patch over flattened flaps (F3, F4) is performed to obtain the bag with valve as shown in FIG. 8 and the process ends.

Shown in FIG. 8 is the typical flat bottom bag with valve (800) obtained from the process (700). The flat bottom bag (800) has a valve open mouth (802) which may be closed or sealed after filling the bag (800) with the desired content in order to provide hermetically sealed bag (800). In an embodiment of the present invention, the open mouth (802) may be sealed by sealing the inner surfaces of the valve (28) using any sealing methods known in the art. In an alternative embodiment, the protruding valve (28) may be folded and sealed to close the bag (800) and provide a hermetically sealed package (800).

The steps in the processes (100) and (700) have been described in sequential manner with reference to FIGS. 1, 7 and 7A. However, the sequence may be changed if required and possible.

The advantages of the invention are that the bags with valves are produced from single web making it possible to have continuous registered or unregistered printing all around the outer surface of the bags using rotogravure, flexographic, digital or any other method. Extrusion coating on the outer surface of the bags can also be done all over prior to printing without leaving protrusion on the side edges of the bags. Possibility of using laminate of WPP/WPE as shown in FIG. 6A is also achieved. All such possibilities give better aesthetic value to the bags.

The foregoing descriptions of specific embodiments of the invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the invention.

1. A method (100) for making a flat bottom bag with a valve (800), the method (100) comprising steps of:
a. overlapping and sealing the two longitudinal edges (11a and 11b) of a web (10) to form a continuous tube (12);
b. cutting-off the continuous tube (12) into tube pieces (14) in accordance with desired bag length, each tube piece (14) has at least a first open end (18) and a second open end (22);
c. forming a first pair of flaps (F1, F2) and a second pair of flaps (F3, F4) on the first open end (18) and the second open end (22) respectively;
d. providing a valve (28) on the second pair of flaps (F3, F4) on the second open end (22);
e. folding and flattening both the pairs of flaps (F1, F2, and F3, F4) at both the open ends (18, 22) of the tube piece (14) so that the edges of the flaps (F1, F2, and F3, F4) meet at the centre; and
f. sealing a pre-cut cover patch (30) onto the folded and flattened pairs of flaps (F1, F2, and F3, F4) at both the ends of the tube piece (14) to close the open-ends (18, 22) to form the bag (800).

2. The method (100) as claimed in claim 1, wherein the method (100) includes the step of pulling the web (10) from an unwinder, wherein the web (10) is an unprinted or printed woven fabric including a Woven Polypropylene (WPP) or Woven High Density Polyethylene (WPE), wherein the woven fabric is at least extrusion coated, printed, or coated with radiation curable coating over printing and radiation cured or a combination thereof.

3. The method (100) as claimed in claim 1, wherein the step of forming a pair of flaps (F1, F2, and F3, F4) includes folding the ends (18, 22) of the tube (14) vertically, spreading the mouth of the folded open-ends (18, 22) of the tube (14), and flattening the mouths of the folded open-ends (18, 22) of the tube (14) to form the first pair of flaps (F1, F2) on the first open-end (18) and the second pair of flaps (F3, F4) on the second open-end (22).

4. The method (100) as claimed in claim 1, wherein the valve (28) is provided such that the valve (28) protrudes outside the edge of the tube (14).

5. The method (100) as claimed in claim 1, wherein the step of providing the valve (28) further includes:
sealing a cut laminate piece (26) to the second pair of flaps (F3, F4) of the second open end (22), wherein the cut laminate piece (26) is protruding out of the edges of the tube (14) by a predefined offset distance (Do) and a predefined mouth distance (Dm) from the side of the flap on the second open end (22); and folding the cut laminate piece (26) to form the valve (28).

6. The method (100) as claimed in claim 6, wherein the precut laminate piece (26) is made up of at least one of Woven Polypropylene (WPP) or High Density Woven Polyethylene (WPE) fabric with or without extrusion coating of Polypropylene or Polyethylene or a combination of both, on one or both the sides.

7. The method (100) as claimed in claim 1, wherein the step of providing the valve (28) on the second pair of flaps (F3, F4) includes sealing an offline pre-formed tube as valve (28) to the second pair of flaps (F3, F4) on the second open end (22).

8. The method (100) as claimed in claim 1, wherein the at least one of the steps of sealing is performed using at least one of heat sealing, sealing with hot melt adhesive, hot air sealing, ultrasonic sealing, sealing using glue, sealing with hot extrusion layer or by Laser welding.

9. The method (100) as claimed in claim 1, wherein the pre-cut cover patch (30) is at least one of printed or unprinted, single layer or multilayer film or laminate having compatible surface material for sealing with the pairs of flaps surface.

10. A flat bottom bag (800) having center longitudinal seal made by using method (100) of claim 1.

11. The flat bottom bag (800) as claimed in claim 10, wherein the valve (28) protrudes outside the edges of the bag (800).

12. The flat bottom bag (800) as claimed in claim 11, wherein an open mouth (802) of the protruding valve (28) is sealed after filling the bag (800).
